(19) United States
(12) Patent Application Publication
(10) Pub. No.: US 2024/0278394 A1
(43) Pub. Date: Aug. 22, 2024

(54) IMPACT TOOL

(71) Applicant: Nanjing Chervon Industry Co., Ltd., Nanjing (CN)

(72) Inventors: Yuyi Zheng, Nanjing (CN); Rui Xu, Nanjing (CN); Shubin Tong, Nanjing (CN); Di Wu, Nanjing (CN); Hanhua Liu, Nanjing (CN)

(21) Appl. No.: 18/537,166

(22) Filed: Dec. 12, 2023

(30) Foreign Application Priority Data
Feb. 17, 2023 (CN) 202320249593.X

(51) Int. Cl. B25B 21/02

(52) U.S. Cl. CPC B25B 21/02

(57) ABSTRACT

An impact tool includes an electric motor, an output shaft, a grip, and an impact assembly. The impact assembly is used for providing an impact force for the output shaft and includes an impact block driven by the electric motor and a hammer anvil mating with the impact block and impacted by the impact block. The maximum radial dimension of the impact block is greater than or equal to 44 mm and less than or equal to 50 mm, and tightening torque outputted from the impact tool to a workpiece is greater than or equal to 250 N·m. The impact tool ensures good impact performance and is compact and light.

### RELATED APPLICATION INFORMATION

This application claims the benefit under 35 U.S.C. §119(a) of Chinese Patent Application No. CN 202320249593.X, filed on Feb. 17, 2023, which application is incorporated herein by reference in its entirety.

### TECHNICAL FIELD

The present application relates to the technical field of power tools and, in particular, to an impact tool.

### BACKGROUND

An impact tool refers to a tool capable of outputting rotational movements at a certain impact frequency. Common impact tools include an impact wrench, an impact screwdriver, an impact drill, and the like. The impact wrench is typically used for screwing bolts, nuts, and the like. The impact screwdriver is typically used for loosening or tightening screws and the like. The impact drill is typically used for drilling holes through impact.

To output the rotational movements at a certain impact frequency, the impact tool typically includes an output assembly for outputting a rotational force and an impact assembly for impacting the output assembly cyclically. The relatively large axial dimension of an existing impact assembly results in the relatively large volume of the whole impact tool, thereby resulting in that the use environment of the impact tool is limited. Particularly, in the working condition of a narrow and small space, a power tool having a relatively large volume cannot enter the space smoothly and even cannot work, resulting in the reduction of working efficiency. However, if the axial dimension of the impact assembly is reduced to a relatively large degree, the impact performance of the impact tool will be affected.

This part provides background information related to the present application, which is not necessarily the existing art.

### SUMMARY

An impact tool includes: a housing; an electric motor accommodated in the housing and including a drive shaft rotating about an electric motor axis; an output shaft used for outputting power; a grip connected to or formed on the housing; and an impact assembly used for providing an impact force for the output shaft and including an impact block driven by the electric motor and a hammer anvil mating with the impact block and impacted by the impact block. The maximum radial dimension R1 of the impact block is greater than or equal to 44 mm and less than or equal to 50 mm, and tightening torque outputted from the impact tool to a workpiece is greater than or equal to 250 N·m.

In some examples, a length L1 from the rear end of the housing to the front end of the output shaft is less than or equal to 110 mm.

In some examples, a transmission assembly is further included, used for transmitting power outputted from the drive shaft to the impact assembly, and disposed between the electric motor and the impact assembly.

In some examples, the maximum impact frequency of the impact block of the impact tool is greater than or equal to 2500 bpm and less than or equal to 3900 bpm.

In some examples, the mass of the impact block is greater than 110 g.

In some examples, the mass of the impact block is greater than or equal to 150 g.

In some examples, the ratio of a moment of inertia of the impact block to the tightening torque outputted from the impact tool is greater than or equal to 1.5×10⁻⁴ kg·mm/N and less than or equal to 1.9×10⁻⁴ kg·mm/N.

In some examples, the electric motor includes a stator assembly and a rotor

assembly which rotates about the electric motor axis, and the drive shaft is formed in or connected to the rotor assembly.

In some examples, the ratio of the maximum radial dimension R1 of the impact block to the maximum radial dimension R2 of the stator assembly is greater than or equal to 0.8 and less than or equal to 1.2.

In some examples, the impact assembly further includes an elastic member disposed between the impact block and the transmission assembly, where the elastic member is capable of becoming shorter or longer between the impact block and the transmission assembly so that the impact block is driven to be displaced along the deformation direction of the elastic member, and the elastic coefficient K of the elastic member is greater than or equal to 10 N/mm and less than or equal to 20 N/mm.

In some examples, a battery pack is further included, and the battery pack powers at least the electric motor, where the nominal voltage of the battery pack is greater than or equal to 4 V and less than or equal to 80 V.

In some examples, the drive shaft is provided, along the direction of the electric motor axis, with a front bearing disposed in front of the stator assembly, and the impact assembly includes a main shaft supporting the impact block and driven to rotate by the drive shaft.

In some examples, the main shaft is provided with a main shaft bearing supporting the rotation of the main shaft, where the main shaft bearing at least partially overlaps with the front bearing in the direction of the electric motor axis, and the length of an overlapping portion is greater than 0 mm and less than 4 mm.

In some examples, the distance L2 between the front end surface of the main shaft bearing and the front end surface of the front bearing is less than or equal to 5 mm along the direction of an electric motor axis.

In some examples, a fan is further included and supported by the drive shaft, where the dimension of the fan along the electric motor axis is greater than or equal to 2 mm and less than or equal to 3.5 mm.

An impact tool includes: a housing; an electric motor accommodated in the housing and including a drive shaft rotating about an electric motor axis; an output shaft used for outputting power; a grip connected to or formed on the housing; an impact assembly used for providing an impact force for the output shaft and including an impact block driven by the electric motor and a hammer anvil mating with the impact block and impacted by the impact block; and a transmission assembly used for transmitting power outputted from the drive shaft to the impact assembly and disposed between the electric motor and the impact assembly. A length L1 from the rear end of the housing to the front end of the output shaft is less than or equal to 110 mm, and tightening torque outputted from the impact tool to a workpiece is greater than or equal to 250 N·m.

An impact tool includes: a housing; an electric motor accommodated in the housing and including a drive shaft rotating about an electric motor axis; an output shaft used for outputting power; a grip connected to or formed on the housing; and an impact assembly used for providing an impact force for the output shaft and including an impact block driven by the electric motor and a hammer anvil mating with the impact block and impacted by the impact block. The weight of the impact block is greater than 110 g, the maximum impact frequency of the impact tool is greater than or equal to 2500 bpm and less than or equal to 3900 bpm, and tightening torque outputted from the impact tool to a workpiece is greater than or equal to 250 N·m.

In some examples, the mass of the impact block is greater than or equal to 150 g.

In some examples, the ratio of a moment of inertia of the impact block to the tightening torque outputted from the impact tool is greater than or equal to 1.5×10⁻⁴ kg·mm/N and less than or equal to 1.9×10⁻⁴ kg·mm/N.

In some examples, a length L1 from the rear end of the housing to the front end of the output shaft is less than or equal to 110 mm.

### BRIEF DESCRIPTION OF THE DRAWINGS

FIG. 1 is a schematic view of an impact tool according to an example of the present application;

FIG. 2 is a sectional view of an impact tool according to an example of the present application;

FIG. 3 is an enlargement view of a structure shown in FIG. 2;

FIG. 4 is an exploded view of an impact tool according to an example of the present application;

FIG. 5 is a top view of the structures in FIG. 4;

FIG. 6 is a schematic view of a fan of an impact tool at an angle of view according to an example of the present application;

FIG. 7 is a schematic view of a fan of an impact tool at another angle of view according to an example of the present application;

FIG. 8 is a side view of a fan of an impact tool according to an example of the present application; and

FIG. 9 is a sectional view along a direction B-B in FIG. 8.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

To clearly illustrate technical solutions of the present application, an upper side, a lower side, a front side, and a rear side are defined in the drawings of the specification.

The present application provides an impact tool 10. In this example, an impact wrench is used as an example. In other alternative examples, an impact tool 10 may be a tool capable of outputting a rotational movement, for example, an impact drill or an impact screwdriver. Different work attachments are used so that the impact tool 10 has different functions and can perform different tasks.

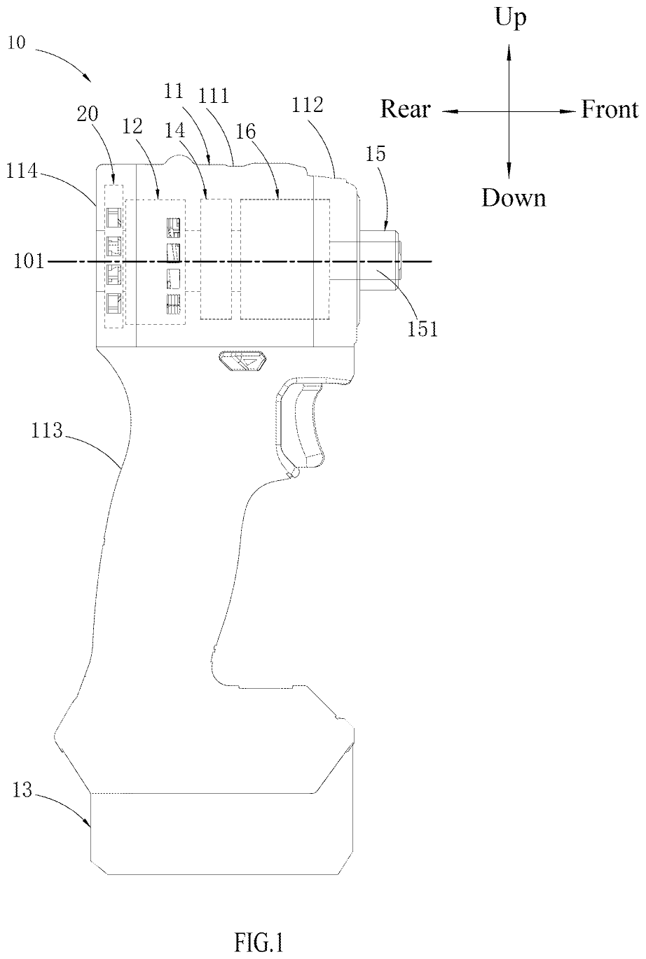

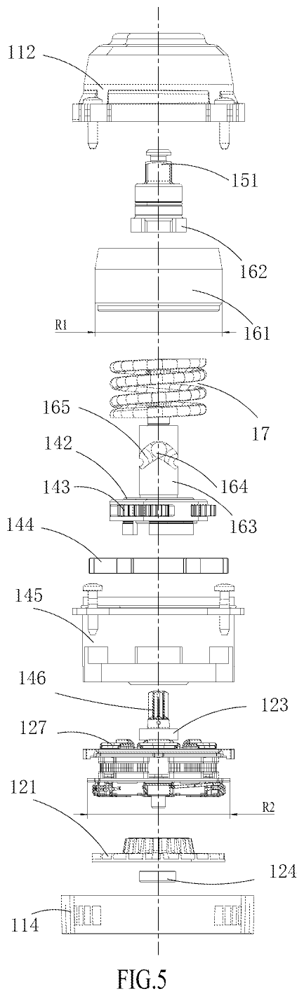

As shown in FIGS. 1 to 5, in this example, the impact tool 10 further includes a power supply. The power supply is used for supplying electrical energy to the impact tool 10. In this example, the power supply is a battery pack 13, and the battery pack 13 cooperates with a corresponding power supply circuit to power corresponding components in the impact tool 10. It is to be understood by those skilled in the art that the power supply is not limited to the scenario where the battery pack 13 is used, and corresponding components in an impact screwdriver 100 may be powered through mains electricity or an alternating current power supply which cooperates with a corresponding rectifier circuit, filter circuit, and voltage regulation circuit. In some examples, the battery pack 13 may be a lithium battery pack, a solid-state battery pack, or a pouch battery pack. The nominal voltage of the battery pack 13 is greater than or equal to 4 V and less than or equal to 80 V. In one example, the nominal voltage of the battery pack 13 is greater than or equal to 10 V and less than or equal to 48 V.

The impact tool 10 includes a housing 11, an electric motor 12, an output assembly 15, a transmission assembly 14, and an impact assembly 16. The housing 11 is the main protective member and mounting member of the impact tool 10, and the inner wall surface of the housing 11 encloses an accommodating space. The housing 11 includes an electric motor housing 111 for accommodating the electric motor 12 and an output housing 112 for accommodating at least part of the output assembly 15. The output housing 112 is connected to the front end of the electric motor housing 111. The battery pack 13 may be mounted in or outside the accommodating space as desired.

In some examples, the housing 11 has a split structure. In one example, the housing 11 may have a structure composed of two parts. For example, the housing 11 includes a left half housing and a right half housing, a front half housing and a rear half housing, or an upper half housing and a lower half housing which can be spliced together. In this example, the housing 11 further includes a rear end cover 114, and the rear end cover 114 is disposed at the rear end of the electric motor housing 111.

The housing 11 is also formed with or connected to a grip 113 for a user to operate. The grip 113 and the electric motor housing form a T-shaped or L-shaped structure, which is convenient for the user to hold and operate. The power supply 30 is connected to an end of the grip 113. The power supply 30 is detachably connected to the grip 113.

In some examples, in order to reduce the mass of the whole impact tool 10, the housing 11 is made of plastic. At least part of the housing 11 is made of metallic materials.

The electric motor 12 includes a drive shaft 122 rotating about an electric motor axis 101.

The output assembly 15 includes an output shaft 151 for connecting a work attachment and driving the work attachment to rotate. The output shaft 151 is used for outputting power and rotates about an output axis. In this example, the electric motor axis 101 coincides with the output axis. In other alternative examples, the electric motor axis 101 is parallel to but does not coincide with the output axis. In other alternative examples, the electric motor axis 101 intersects the output axis at an angle.

In this example, a clamping portion is formed at or connected to an end of the output shaft 151 and may clamp corresponding work attachments to implement different functions, such as a screwdriver, a drill bit, and a socket.

The electric motor 12 is a power component of the impact tool 10. The electric motor 12 is disposed in the housing 11. The electric motor 12 may have an independent electric motor housing or may directly use the housing 11 as an electric motor housing. The electric motor 12 includes a stator assembly 127 and a rotor assembly 128 which includes the drive shaft 122 for outputting power. One end of the drive shaft 122 is connected to a fan 20, and the other end of the drive shaft 122 is connected to the transmission assembly 14. The drive shaft 122 rotates about the electric motor axis 101, and during the rotation of the drive shaft 122, the fan 20 can rotate synchronously, thereby achieving the object to dissipate heat of the electric motor 12. To enable the drive shaft 122 to stably rotate about the electric motor axis 101, a front bearing 123 and a rear bearing 124 are spaced in the front and rear of the accommodating space of the housing 11 along the direction of the electric motor axis 101. The rear bearing 124 is disposed in a bearing housing 125, the bearing housing 125 is fixedly disposed on the rear end cover 114, and two ends of the drive shaft 122 are rotatably supported in the front bearing 123 and the rear bearing 124 separately.

In some examples, the diameter of the electric motor 12 is greater than or equal to 40 mm and less than or equal to 53 mm. In some examples, the diameter of the electric motor 12 is greater than or equal to 40 mm and less than or equal to 50 mm. In some examples, the diameter of the electric motor 12 is 41 mm, 42 mm, 43 mm, 44 mm, 45 mm, 46 mm, 47 mm, 48 mm, 49 mm, 50 mm, 51 mm, or 52 mm. In some examples, the length of an iron core of the stator assembly 127 is less than or equal to 10 mm. It is to be understood that the length of the iron core of the stator may be represented by the stack length of the electric motor.

In some examples, the diameter of the fan 20 is greater than or equal to 46 mm and less than or equal to 53 mm. In some examples, the height of the fan 20 (that is, the dimension of the fan 20 in the direction of the electric motor axis 101) is greater than or equal to 2 mm and less than or equal to 3.5 mm. In some examples, part of the rear end surface of the fan 20 is recessed forwardly to form a slot in which the rear bearing 124 is placed. Thus, the compactness of the internal structure of the whole impact tool 10 can be improved, thereby further reducing the dimension of the whole impact tool 10 along the electric motor axis 101.

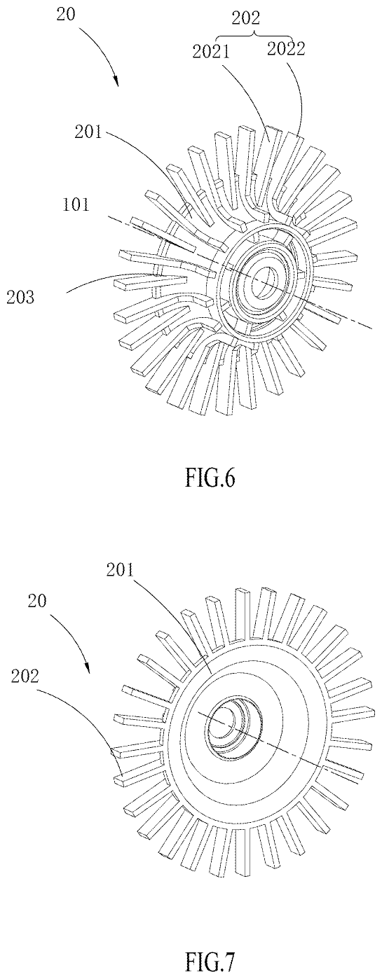

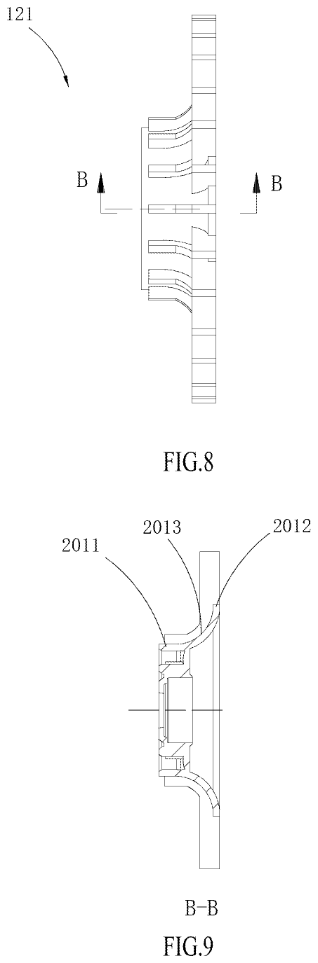

As an alternative example, as shown in FIGS. 6 to 9, the fan 20 includes a fan base plate 201 and fan blades 202. The fan base plate 201 includes a first portion 2011 extending along a first direction, a second portion 2012 extending along a second direction, and a connecting portion 2013 connecting the first portion 2011 to the second portion 2012. The second portion 2012 radially expands relative to the first portion 2011 along the electric motor axis 101, and the connecting portion 2013 extends along the electric motor axis 101 and along an Archimedean spiral or a logarithmic spiral. In this example, the first direction refers to the extension direction of the electric motor axis 101 or a direction parallel to the electric motor axis 101. The second direction is perpendicular to the first direction, and in other examples, the second direction may intersect the first direction. Multiple fan blades 202 are disposed along the circumferential direction of the electric motor axis 101. The fan blades 202 include first fan blades 2021 and second fan blades 2022. Both a first blade 2021 and a second blade 2022 are disposed on the fan base plate 201. Each of the first blade 2021 and the second blade 2022 includes an inner edge portion connected to the fan base plate 201. The length of the inner edge portion of the first blade 2021 is greater than the length of the inner edge portion of the second blade 2022. In one example, the first blades 2021 and the second blades 2022 are spaced along the circumferential direction of the electric motor axis 101. Along a direction perpendicular to the electric motor axis 101, the fan base plate 201 covers part of each of the fan blades 202. The fan 20 is configured in this manner so that the fluidity of an air path of the fan 20 is effectively improved through the Archimedean curve. Further, the dimension of the fan 20 can be reduced, thereby reducing the overall axial dimension of the power tool.

The transmission assembly 14 is disposed in the housing 11 and disposed between the electric motor 12 and the impact assembly 16. The transmission assembly 14 is used for transmitting power outputted from the drive shaft 122 to the impact assembly 16. In this example, the transmission assembly 14 is decelerated by a planet gear. In one example, the transmission assembly 14 includes a gearbox housing 145, a sun gear 146, a planet carrier 142, a planet gear 143, and a ring gear 144. The gearbox housing 145 may be a housing independent of the housing 11, or part of the housing 11 may be directly used as the gearbox housing 145. Thus, the structure of the impact tool 10 can be simplified, the structural compactness of the impact tool 10 is improved, and the weight of the impact tool 10 is reduced.

The ring gear 144 is fixedly disposed relative to the gearbox housing 145, and the planet carrier 142 includes a base and multiple planet shafts disposed on an end surface of the base along the circumferential direction of the base. Multiple planet gears 143 are provided, and one planet gear 143 is sleeved on each planet shaft. The electric motor shaft of the electric motor 12 extends into the gearbox housing 145, and the electric motor shaft 122 is connected to the sun gear 146. The planet gear 143 simultaneously meshes with the sun gear 146 and the ring gear 144.

The electric motor shaft 122 drives the sun gear 146 to rotate about the electric motor axis 101, and driven by the sun gear 146, the planet gear 143 crawls along the ring gear 144 while rotating around the sun gear 146. The planet carrier 142 rotates around the electric motor axis 101. It is to be noted that since the working principles according to which the planet gear performs the deceleration and the deceleration is implemented by the transmission assembly have been completely disclosed to those skilled in the art, a detailed description is omitted here for the brevity of the specification.

In some examples, the gear ratio of the transmission assembly 14 is greater than or equal to 7 and less than or equal to 10. For example, the gear ratio of the transmission assembly 14 may be 7, 8, 9, or 10. In some examples, the ratio of the rotational speed of the loaded electric motor 12 to the gear ratio is greater than or equal to 1500 rpm and less than or equal to 2500 rpm. The ratio of the rotational speed of the loaded electric motor 12 to the gear ratio is greater than or equal to 1500 rpm and less than or equal to 2100 rpm.

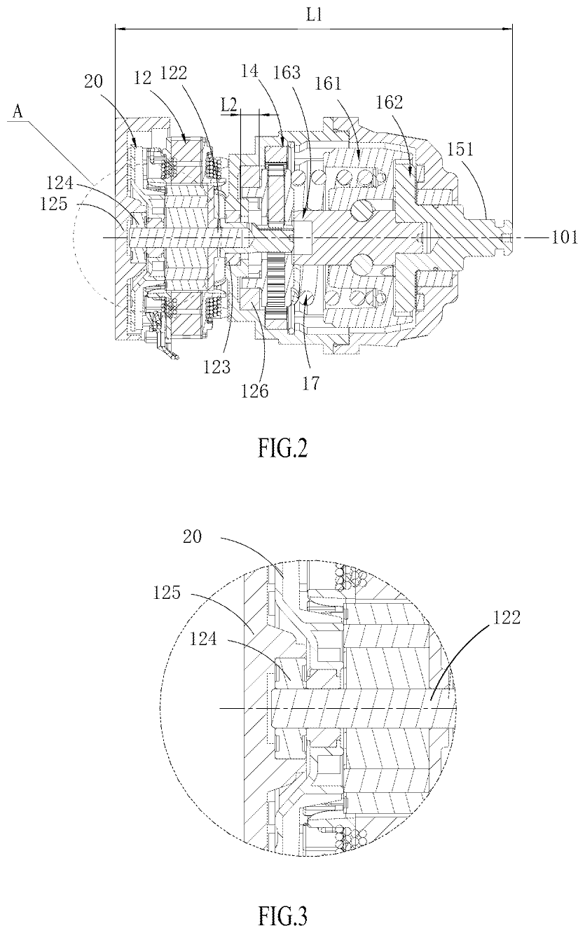

The impact assembly 16 is disposed in the housing 11 and disposed between the transmission assembly 14 and the output shaft 151. The impact assembly 16 is used for providing an impact force for the output shaft 151. With continued reference to FIGS. 2 to 4, the impact assembly 16 includes a main shaft 163, an impact block 161, and a hammer anvil 162. The power generated by the electric motor 12 is transmitted to the main shaft 163 via the transmission assembly 14, thereby driving the impact block 161, and the hammer anvil 162 mates with the impact block 161 and is struck by the impact block 161. In this example, the main shaft 163 is drivingly connected to the planet carrier 142, or the main shaft 163 and the planet carrier 142 are integrally formed with each other, and the main shaft 163 is supported by a main shaft bearing 126. The electric motor shaft 122 drives the sun gear 146 to rotate about the electric motor axis 101. Driven by the sun gear 146, the planet gear 143 crawls along the ring gear 144 while rotating around the sun gear 146. The planet carrier 142 rotates around the electric motor axis 101, thereby driving the main shaft 163 to rotate about the electric motor axis 101.

In one example, a pair of first end teeth are radially disposed on the front end surface of the impact block 161 symmetrically, and a pair of second end teeth are radially disposed on the rear end surface of the hammer anvil 162 opposite to the impact block 161 symmetrically, where the second teeth and the first teeth mate with each other to be used. The hammer anvil 162 and the output shaft 151 are integrally formed with each other, or the hammer anvil 162 is fixedly connected to the output shaft 151. A mounting slot for mounting the different work attachments is disposed at the front end of the output shaft 151. The work attachments include but are not limited to the screwdriver, the drill bit, the socket, and the like. The impact assembly 16 further includes a ball track 165 and a ball 164. The ball track 165 is composed of two parts, where one part is formed on the main shaft 163, and the other part is formed on the inner wall surface of the impact block 161. The ball 164 is disposed in the ball track 165 and disposed between the main shaft 163 and the impact block 161. In some examples, the ball track 165 is generally V-shaped.

In some examples, the main shaft bearing 126 at least partially overlaps with the front bearing 123 in the direction of the electric motor axis 101, and the length of an overlapping portion is greater than 0 mm and less than 4 mm. In some examples, the distance L2 between the front end surface of the front bearing 123 and the front end surface of the main shaft bearing 126 is less than or equal to 5 mm in the direction of the electric motor axis 101. Thus, the compactness of the internal structure of the whole impact tool 10 can be improved, thereby further reducing the dimension of the whole impact tool 10 along the electric motor axis 101.

The impact block 162 is supported on the main shaft 163 and rotates integrally with the main shaft 163. In addition, the impact block 161 may reciprocate relative to the main shaft 41 in the axial direction of the main shaft 163. In this example, the axis of the main shaft 163 coincides with the electric motor axis 101. Therefore, the impact block 161 reciprocates and rotates relative to the main shaft 163 along the direction of the electric motor axis 101. In other alternative examples, the axis of the main shaft 163 may be parallel to but does not coincide with the electric motor axis 101.

In some examples, the maximum radial dimension R1 of the impact block 161 is greater than or equal to 44 mm and less than or equal to 50 mm. For example, the maximum radial dimension R1 of the impact block 161 may be 44 mm, 45 mm, 46 mm, 47 mm, 48 mm, 49 mm, or 50 mm. In some examples, tightening torque outputted from the impact tool 10 to a workpiece is greater than or equal to 250 N·m. The “tightening torque” refers to torque applied to the workpiece in the direction (that is, in a tightening direction) in which tension is increased, and a standard measurement under laboratory conditions is necessary for measuring the “tightening torque”. In some examples, the “tightening torque” is the nominal torque of a product.

Compared with an existing impact tool 10, the impact tool 10 provided by the example of the present application has the impact block 161 whose axial dimension can be properly reduced because the radial dimension of the impact block 161 is increased. Thus, the axial dimension of the whole impact tool 10 is reduced, thereby making the whole impact tool 10 more compact. In addition, the diameter of the impact block 161 is increased so that the weight of the impact block 161 can be increased. Thus, the impact tool 10 can maintain good impact performance.

In some examples, the tightening torque outputted from the impact tool 10 to the workpiece is greater than or equal to 250 N·m and less than or equal to 500 N·m. For example, the tightening torque outputted from the impact tool 10 to the workpiece may be 250 N·m, 300 N·m, 350 Nm, 400 N·m, 450 N·m, or 500 N·m.

When the impact tool 10 is in operation, the electric motor 12 is started. The electric motor shaft 122 of the electric motor 12 rotates about the electric motor axis 101, and the electric motor shaft drives the sun gear 146 to rotate about the electric motor axis 101. Driven by the sun gear 146, the planet gear 143 rotates around the sun gear 146 and crawls along gear teeth of the ring gear 144. The planet gear 143 orbitally rotates around the sun gear 146 to drive the planet carrier 142 to rotate about the electric motor axis 101. The planet carrier 142 transmits the rotational movement to the main shaft 163 so that the main shaft 163 synchronously rotates about the electric motor axis 101. Since the ball 164 is disposed between the main shaft 163 and the impact block 161, the main shaft 163 may drive, via the ball 164, the impact block 161 to rotate, and the impact block 161 mates with the hammer anvil 162 to be capable of further driving the output shaft 151 to rotate.

When the impact tool 10 is not loaded, that is, no load is applied to the output shaft 151, the impact assembly 16 does not impact, and the impact assembly 16 only performs a transmission function to transmit the rotational movement of the electric motor shaft to the output shaft 151 via the transmission assembly 14 and the impact assembly 16. When a load is applied to the impact tool 10, the rotation of the output shaft 151 is blocked. If the load is large enough, the output shaft 151 stops rotating directly. When the output shaft 151 stops rotating, the hammer anvil 162 stops rotating accordingly. Since the hammer anvil 162 limits the impact block 161 in a circumferential direction, the impact block 161 stops rotating accordingly. However, since the main shaft 163 is still rotating, the ball 164 in the ball track 165 is pressed, and the ball 164 moves along the ball track 165 under this pressing force so that the impact block 161 is driven to be linearly displaced along the electric motor axis 101. The elastic member 17 can be compressed through the movement of the impact block 161 until the impact block 161 and the hammer anvil 162 are completely disengaged from each other. In this case, since the main shaft 163 is still driving the impact block 161 to rotate, the elastic body springs back along the electric motor axis 101 to enable the impact block 161 to be in contact with the hammer anvil 162 and apply an impact force to the hammer anvil 162. Under the action of the impact force, the output shaft 151 can rotate by an angle against the load and then stop rotating again. This process is cyclically performed so that the output shaft 151 can output a continuous impact force.

In some examples, the mass of the impact block 161 is greater than 110 g so that the impact tool 10 can maintain the good impact performance. In some more specific examples, the mass of the impact block 161 is greater than or equal to 150 g.

In some examples, a moment of inertia of the impact block 161 is greater than or equal to 45 kg·mm². In some examples, a moment of inertia of the impact block 161 is greater than or equal to 49 kg·mm².

In some examples, the maximum impact frequency of the impact tool 10 is greater than or equal to 2500 bpm and less than or equal to 3900 bpm. For example, the maximum impact frequency of the impact tool 10 may be 2500 bpm, 2600 bpm, 2700 bpm, 2800 bpm, 2900bpm, 3000 bpm, 3100 bpm, 3200 bpm, 3300 bpm, 3400 bpm, 3500 bpm, 3600 bpm, 3700 bpm, 3800 bpm, or 3900 bpm. It is to be noted that an “impact frequency” refers to the number of impacts applied to the hammer anvil 162 by the impact block 161 per unit time, which is measured in “the number of impacts per minute”.

The impact frequency and the moment of inertia of the impact block 161 together determine the magnitude of the output torque. That is, the greater the impact frequency and the greater the moment of inertia of the impact block 161, the greater the output torque.

In some examples, the ratio of the moment of inertia of the impact block 161 to the tightening torque outputted from the impact tool 10 to the workpiece is greater than or equal to 1.5×10⁻⁴ kg·mm/N and less than or equal to 1.9×10⁻⁴ kg·mm/N.

In some examples, the ratio of the maximum radial dimension R1 of the impact block 161 to the maximum radial dimension R2 of the electric motor 12 is greater than or equal to 0.8 and less than or equal to 1.2. For example, the ratio may be 0.8, 0.9, 1.0, 1.1, or 1.2. In this example, the electric motor is an inner rotor motor, so the maximum radial dimension R2 of the electric motor 12 may be the maximum radial dimension of the stator assembly 127.

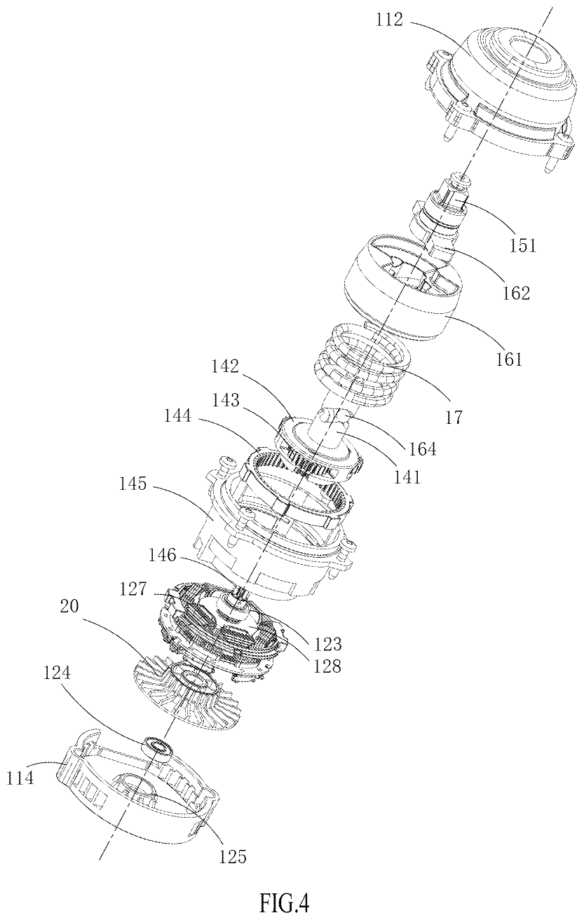

In some examples, as shown in FIG. 4, the length Ll from the rear end of the housing 11 to the front end of the output shaft 151 is less than or equal to 110 mm, thereby making the whole impact tool 10 compact and easy to operate. In some more specific examples, the length L1 from the rear end of the housing 11 to the front end of the output shaft 151 is greater than or equal to 90 mm and less than or equal to 110 mm. For example, the length L1 may be 90 mm, 100 mm, 104 mm, or 110 mm.

With continued reference to FIGS. 2 to 4, the elastic member 17 is disposed between the impact block 161 and the planet carrier 142, where the elastic member 17 is capable of becoming shorter or longer between the impact block 161 and the transmission assembly 14 so that the impact block 161 is driven to be displaced along the deformation direction of the elastic member 17, that is, the elastic member 17 is used for providing a force for the impact block 161 to cause the impact block 161 to approach the hammer anvil 162. In some examples, the elastic member 17 is a coil spring.

In some examples, the elastic coefficient K of the elastic member 17 is greater than or equal to 10 N/mm and less than or equal to 20 N/mm. For example, the elastic coefficient K of the elastic member 17 may be 10 N/mm, 12 N/mm, 15 N/mm, 17 N/mm, 18 N/mm, or 20 N/mm.

In some examples, after the impact block 161 and the coil spring are mounted in place, the value of the elastic force of the coil spring is greater than or equal to 200 N and less than or equal to 400 N.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. An impact tool, comprising:
a housing;
an electric motor accommodated in the housing and comprising a drive shaft rotating about an electric motor axis;
an output shaft used for outputting power;
a grip connected to or formed on the housing; and
an impact assembly used for providing an impact force for the output shaft and comprising an impact block driven by the electric motor and a hammer anvil mating with the impact block and impacted by the impact block;
wherein a maximum radial dimension R1 of the impact block is greater than or equal to 44 mm and less than or equal to 50 mm, and tightening torque outputted from the impact tool to a workpiece is greater than or equal to 250 N·m.

2. The impact tool according to claim 1, wherein a length L1 from a rear end of the housing to a front end of the output shaft is less than or equal to 110 mm.

3. The impact tool according to claim 2, further comprising a transmission assembly used for transmitting power outputted from the drive shaft to the impact assembly and disposed between the electric motor and the impact assembly.

4. The impact tool according to claim 1, wherein a maximum impact frequency of the impact block of the impact tool is greater than or equal to 2500 bpm and less than or equal to 3900 bpm.

5. The impact tool according to claim 4, wherein a mass of the impact block is greater than 110 g.

6. The impact tool according to claim 4, wherein a mass of the impact block is greater than or equal to 150 g.

7. The impact tool according to claim 4, wherein a ratio of a moment of inertia of the impact block to the tightening torque outputted from the impact tool is greater than or equal to 1.5×10⁻⁴ kg·mm/N and less than or equal to 1.9×10⁻⁴ kg·mm/N.

8. The impact tool according to claim 1, wherein the electric motor comprises a stator assembly and a rotor assembly which rotates about the electric motor axis, and the drive shaft is formed in or connected to the rotor assembly.

9. The impact tool according to claim 8, wherein a ratio of the maximum radial dimension R1 of the impact block to a maximum radial dimension R2 of the electric motor is greater than or equal to 0.8 and less than or equal to 1.2.

10. The impact tool according to claim 8, wherein the drive shaft is provided, along a direction of the electric motor axis, with a front bearing disposed in front of the stator assembly, and the impact assembly comprises a main shaft supporting the impact block and driven to rotate by the drive shaft.

11. The impact tool according to claim 10, wherein the main shaft is provided with a main shaft bearing supporting rotation of the main shaft, the main shaft bearing at least partially overlaps with the front bearing in the direction of the electric motor axis, and a length of an overlapping portion is greater than 0 mm and less than 4 mm.

12. The impact tool according to claim 11, wherein a distance L2 between a front end surface of the main shaft bearing and a front end surface of the front bearing is less than or equal to 5 mm along a direction of an electric motor axis.

13. The impact tool according to claim 3, wherein the impact assembly further comprises an elastic member disposed between the impact block and the transmission assembly, the elastic member is capable of becoming shorter or longer between the impact block and the transmission assembly so that the impact block is driven to be displaced along a deformation direction of the elastic member, and an elastic coefficient K of the elastic member is greater than or equal to 10 N/mm and less than or equal to 20 N/mm.

14. The impact tool according to claim 1, further comprising a battery pack powering at least the electric motor, wherein a nominal voltage of the battery pack is greater than or equal to 4 V and less than or equal to 80 V.

15. The impact tool according to claim 1, further comprising a fan supported by the drive shaft, wherein a dimension of the fan along the electric motor axis is greater than or equal to 2 mm and less than or equal to 3.5 mm.

16. An impact tool, comprising:
a housing;
an electric motor accommodated in the housing and comprising a drive shaft rotating about an electric motor axis;
an output shaft used for outputting power;
a grip connected to or formed on the housing;
an impact assembly used for providing an impact force for the output shaft and comprising an impact block driven by the electric motor and a hammer anvil mating with the impact block and impacted by the impact block; and
a transmission assembly used for transmitting power outputted from the drive shaft to the impact assembly and disposed between the electric motor and the impact assembly;
wherein a length L1 from a rear end of the housing to a front end of the output shaft is less than or equal to 110 mm, and a tightening torque outputted from the impact tool to a workpiece is greater than or equal to 250 N·m.

17. An impact tool, comprising:
a housing;
an electric motor accommodated in the housing and comprising a drive shaft rotating about an electric motor axis;
an output shaft used for outputting power;
a grip connected to or formed on the housing; and
an impact assembly used for providing an impact force for the output shaft and comprising an impact block driven by the electric motor and a hammer anvil mating with the impact block and impacted by the impact block;
wherein a weight of the impact block is greater than 110 g, a maximum impact frequency of the impact tool is greater than or equal to 2500 bpm and less than or equal to 3900 bpm, and tightening torque outputted from the impact tool to a workpiece is greater than or equal to 250 N·m.

18. The impact tool according to claim 17, wherein a mass of the impact block is greater than or equal to 150 g.

19. The impact tool according to claim 17, wherein a ratio of a moment of inertia of the impact block to the tightening torque outputted from the impact tool is greater than or equal to 1.5×10⁻⁴ kg·mm/N and less than or equal to 1.9×10⁻⁴ kg·mm/N.

20. The impact tool according to claim 17, wherein a length L1 from a rear end of the housing to a front end of the output shaft is less than or equal to 110 mm.
